(19) United States
(12) Patent Application Publication
(10) Pub. No.: US 2009/0167816 A1
(43) Pub. Date: Jul. 2, 2009

(54) INK JET METHOD FOR FORMING PATTERNED LAYER ON SUBSTRATE

(75) Inventors: Yu-Ning Wang, Hsinchu (TW); Stephen Ko-Chiang Chien, Foster City, CA (US)

Correspondence Address: PCE INDUSTRY, INC.;ATT. Steven Reiss, 458 E. LAMBERT ROAD, FULLERTON, CA, 92835, US

(73) Assignee: ICF TECHNOLOGY LIMITED., Santa Clara, CA (US)

(21) Appl. No.: 11/964,542

(22) Filed: Dec. 26, 2007

(51) Int. Cl. B41J 2/195; B41J 2/165

(52) U.S. Cl. 347/35

(57) ABSTRACT

An ink jet method for forming patterned layers on substrates permits a predetermined number of substrates to have respective patterned layers formed thereon. The inkjet method, however, further prevents clogging of the ink jet system when not in use to coat/layer substrates. A further step is provided, after all the desired substrates have been patterned, that making the liquid level of the ink in the nozzle changed within each predetermined time interval during/over the course of a predetermined amount of time. By changing the liquid level of the ink in the nozzle in a given period, each nozzle is able to remain unclogged (i.e., the ink in a nozzle does not have sufficient time to dry/harden prior to being jetted).

### BACKGROUND

1. Field of the Invention

The present invention relates to ink jet methods and, particularly, to an ink jet method that functions to form a patterned layer on a substrate.

2. Description of Related Art

In order to manufacture a patterned layer on a substrate, an ink jet method is used. This method is more economic than the traditional photolithographic method, since less waste materials and less manufacturing steps. Ink jet technology employing ink jet heads can be used, e.g., for printing of color filters. In order to implement the ink jet method, an ink jet system with a plurality of ink jet heads for jetting ink droplets was developed. Each ink jet head includes an ink chamber, a pressure-generating element (e.g., a piezo-electric element), and a nozzle face with an opening (i.e., a nozzle). The ink chamber is configured (i.e., structured and arranged) for temporary ink storage, whereby the ink is supplied from an external device. The pressure-generating element functions as a driving force for jetting a specific amount of ink stored in the ink chamber. The nozzle face has an opening, through which ink droplets are jetted from the ink chamber.

However, the ink in the opening of the nozzles may harden/dry and thereby clog the respective nozzles, if the ink jet head is left unused for a long time. Conventionally, a capping component is used to seal the ink jet head, so as to prevent the ink from hardening. However, the capping component usually cannot prevent at least some amount of ink from hardening. As a result, an amount of hardening that does occur that may adversely affect functioning of the ink jet head.

What is necessary, therefore, is to provide an ink jet method that can, more efficiently, prevent the nozzles from clogging.

### SUMMARY

In a present embodiment, an ink jet method for forming respective patterned layers on separate substrates includes these following steps:

Step 1: providing an ink jet system and at least one substrate, the ink jet system including an ink jet head module, the ink jet head module containing a plurality of nozzles;

Step 2: jetting ink from the nozzles onto a given substrate to form a patterned layer onto the given substrate;

Step 3: removing the given substrate with the patterned layer formed thereon;

Step 4: making the liquid level of the ink in the nozzle changed within each predetermined time interval during/over the course of a predetermined amount of time.

Other advantages and novel features of the present invention will become more apparent from the following detailed description of the at least one present embodiment when taken in conjunction with the accompanying drawings.

### BRIEF DESCRIPTION OF THE DRAWINGS

Many aspects of the present ink jet method can be better understood with reference to the following drawings. The components in the drawings are not necessarily drawn to scale, the emphasis instead being placed upon clearly illustrating the principles of the present ink jet method. Moreover, in the drawings, like reference numerals designate corresponding parts throughout the several views.

FIG. 1 is a schematic, sectional view of an ink jet system used in the ink jet method, according to a first present embodiment, the ink jet system including an ink jet head module;

FIG. 2 is a schematic, bottom view of the ink jet head module in FIG. 1;

FIG. 3 is a flow chart of an ink jet method, according to a second present embodiment;

FIG. 4 is a schematic, sectional view of an ink jet system used in the ink jet method, according to a third present embodiment;

FIG. 5 is schematic, sectional view of an ink jet system used in the ink jet method, according to a fourth present embodiment; and

FIG. 6 is schematic, sectional view of an ink jet system used in the ink jet method, according to a fifth present embodiment.

### DETAILED DESCRIPTION OF THE EMBODIMENT

Reference will now be made to the drawings to describe the present embodiments of the present inkjet method, in detail.

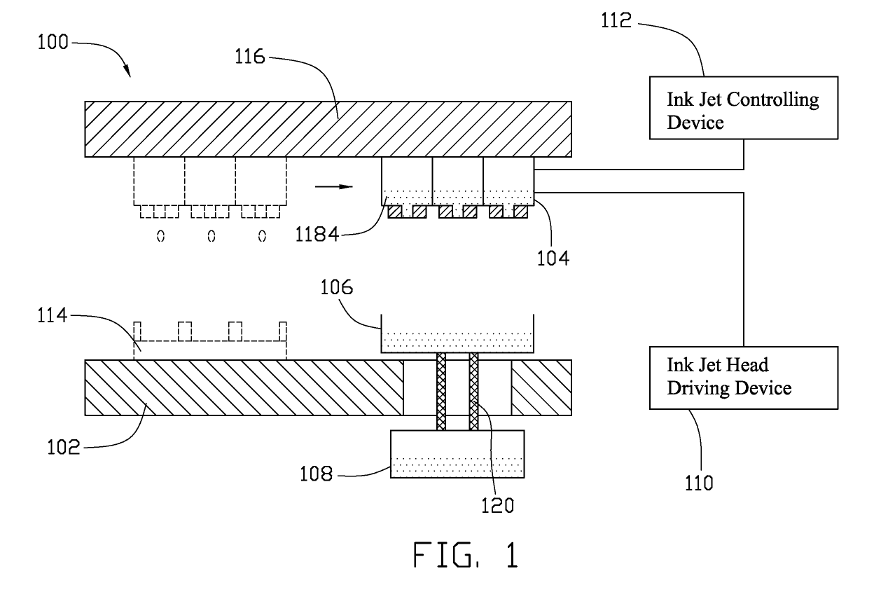

Referring to FIG. 1, an ink jet system 100 is illustrated in accordance with a first present embodiment. The ink jet system 100 includes a worktable 102, an ink jet head module 104, an ink receiver 106, a waste liquid container 108, an ink jet head driving device 110, and an ink jet controlling device 112. A substrate 114 and the ink receiver 106 are disposed on the worktable 102. The ink jet head module 104 is used for jetting ink on the substrate 114 to form a patterned layer on the substrate 114.

The ink receiver 106 can be an object that contain or absorb the ink. In the present embodiments, the ink receiver 106 is used for containing ink jetted from the ink jet head module 104, when the ink jet head module 104 is at/in a non-working state. In this present embodiment, the ink receiver 106 is disposed on the worktable 102. The waste liquid container 108 is connected with the ink receiver 106 by a guide pipe 120, and the ink in the receiver 106 can be guided into the waste liquid container 108. It is to be understood that a means (not shown) may be provided to permit ink received in the waste liquid container 108 to be recycled (e.g., transferred back to the ink supply tank (not shown) to be re-used for ink jetting and/or collected for other use). It is to be further understood that, e.g., three separate waste liquid containers 108 to separately capture three different inks for recycling. Of course, the ink receiver 106 also can be replaced by sponge to absorb the ink and the waste liquid container 108 is omitted.

The ink jet system 100 also includes a guide rail 116. In order to drive the ink jet head module 104 moving over the substrate 114 and over the ink receiver 106, the ink jet head driving device 110 is configured to drive the ink jet head module 104 along the rail mechanism 116. The ink jet controlling device 112 is configured to control jetting quantity and the frequency of the ink jet head module 104. Generally, the ink jet head driving device 110 can, beneficially, be a motor device. Besides, if the inkjet head module 104 is stationary, the work table will be moved so that the ink jet head module 104 is located over the ink receiver 106.

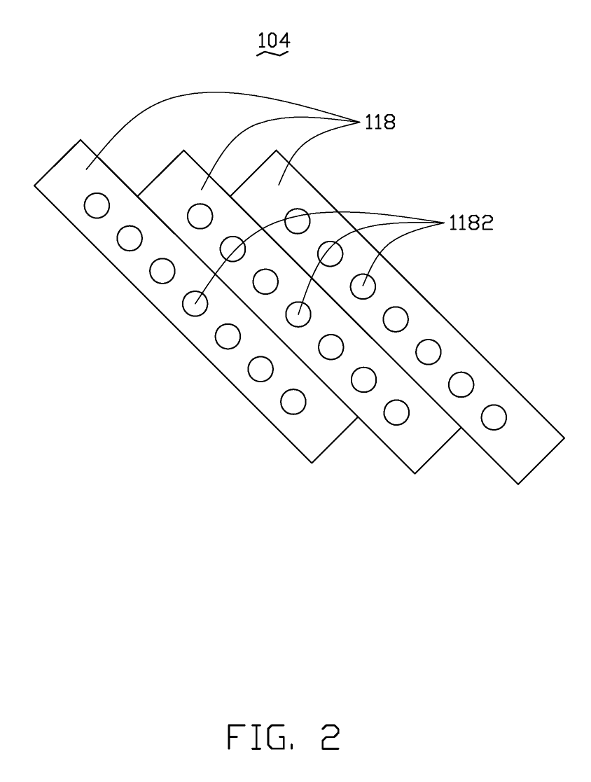

Referring to FIG. 2, the inkjet module 104 is illustrated in accordance with FIG. 1. Basically, the ink jet head module 104 includes a plurality of ink jet heads 118. For example, in this present embodiment, there are three ink jet heads 118 arranged in parallel with each other. The ink jet head 118 is configured for receiving ink 1184. The ink jet head 118 is also configured to apply pressure on the ink 1184 in the ink jet head module 104 to change the liquid level of the ink 1184, then jet ink 1184 to the substrate 114. Each ink jet head 118 has a plurality of nozzles 1182, eight of which are illustrated in this present embodiment. The ink jet head 118 can jet the ink 1184 to the substrate 114 or to the ink receiver 106 from the nozzles 1182 selectively. A material of the ink 1184 can be selected according to need.

It is to be understood that any number of ink jet heads 118 (e.g., one, two, four, five, etc.) can be present in a given ink jet head module 104. Also, the number of the nozzles 1182 within a given ink jet head 118 can be more or less than eight and still be within the scope of the present embodiment.

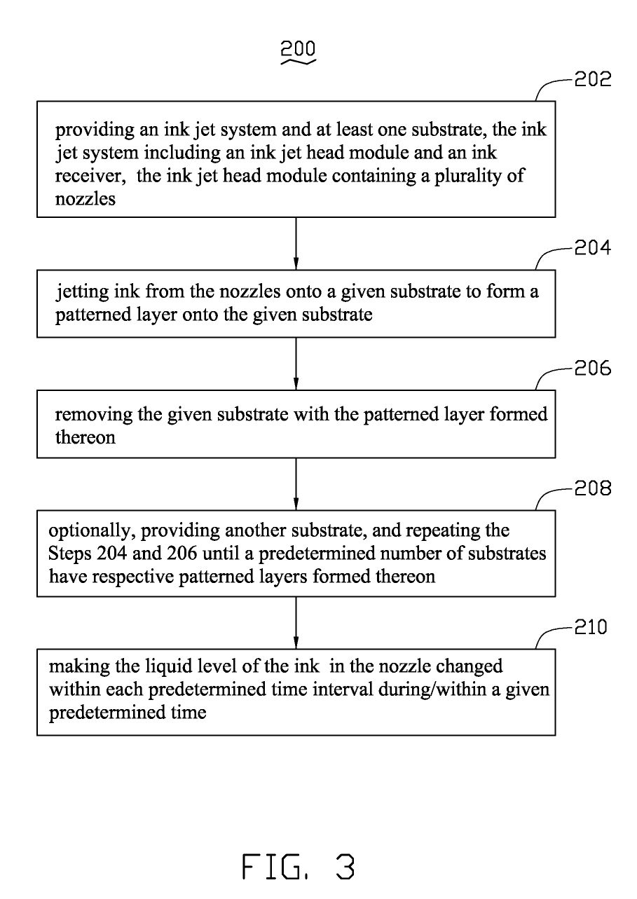

Referring to FIG. 3, an ink jet method 200 is illustrated in accordance to another present embodiment. The ink jet method 200, which can be accomplished using the ink jet system 100 of FIGS. 1 and 2, includes these following steps:

Step 202: providing the ink jet system 100 and at least one substrate 114. A given substrate 114 is disposed on the worktable 102, and the ink jet head module 104 is placed over the given substrate 114.

Step 204: jetting ink from the ink jet head module 104 onto the substrate 114 to form a given patterned layer on the given substrate 114, in order to form, e.g., a color filter, an electroluminescent apparatus, a polymer light emitting diode, or another electro-optical apparatus.

Step 206: removing the given substrate 114, with the given patterned layer formed thereon;

Step 208: optionally, providing another substrate 114, and repeating the Steps 204 and 206 until a predetermined number of substrates 114 have respective patterned layers formed thereon;

Step 210: making the liquid level of the ink 1184 in the nozzle 1182 changed within each predetermined time interval during/within a given predetermined time, in order to prevent the nozzles 1182 from experiencing clogs in the respective openings thereof due to adhesion of hardened/dried ink. In the present embodiment, the change of the liquid level of the ink 1184 is done by the pressure generated by the pressure-generating element (e.g., a piezo-electric element) inside the ink jet head 118. The change of the liquid level of the ink 1184 may cause the liquid level to vibrate or the ink 1184 to jet from the nozzle 1182. The predetermined time interval may vary depending on the material (i.e., composition) of the ink 1184. In general, if the ink 1184 contains a solvent with a higher boiling point (i.e., likely having a relatively low viscosity at room temperature, as well), advantageously, the predetermined time interval is longer. In an alternative scenario, if the ink 1184 contains a solvent with a boiling point that is fairly low (i.e., likely having a relatively high viscosity at room temperature, as well), usefully, the predetermined time interval may be shorter. For example, if a boiling point B1 of the solvent, in the ink 1184, is in a range B1<100° C., the predetermined time interval T1 is roughly in a range of 20 seconds to 5 minutes. Preferably, the predetermined time interval T1 is roughly in a range of 30 seconds to 2.5 minutes. In another example, if a boiling point B2 of the solvent in the ink 1184 is in a range B2>180° C., the predetermined time interval T2 is roughly in a range of 1 minutes to 5 minutes. Preferably, the predetermined time interval T2 is roughly in a range of 1 minute to 3 minutes.

In the present embodiment, Step 210 also can be replaced by a Step 210′ described as below: causing the ink jet head driving device 110 to drive the ink jet head module 104 to have a relative movement to a location over the ink receiver, making the liquid level of the ink 1184 in the nozzle 1182 changed so as to jet a predetermined amount of ink droplets to the ink receiver 106 out of the ink jet head 118 within each predetermined time interval during/within a given predetermined time, in order to prevent the nozzles 1182 from experiencing clogs in the respective openings thereof due to adhesion of hardened/dried ink. The predetermined amount of droplets and the predetermined time interval may vary depending on the material (i.e., composition) of the ink 1184. In general, if the ink 1184 contains a solvent with a higher boiling point (i.e., likely having a relatively low viscosity at room temperature, as well), advantageously, the predetermined amount of droplets is less, and the predetermined time interval is longer. In an alternative scenario, if the ink 1184 contains a solvent with a boiling point that is fairly low (i.e., likely having a relatively high viscosity at room temperature, as well), usefully, the predetermined amount of droplets may be higher (i.e., relative to the above-situation employing a higher boiling-point solvent), and the predetermined time interval may be shorter. For example, if a boiling point B1 of the solvent, in the ink 1184, is in a range B1<100° C., the predetermined number of droplets per each nozzle 1182 is in an approximate range of 100˜5000 droplets, and the predetermined time interval T1 is roughly in a range of 20 seconds to 5 minutes. Preferably, the predetermined amount corresponding to each nozzle 1182 is in a range of 2000˜3000 droplets, and the predetermined time interval Ti is roughly in a range of 30 seconds to 2.5 minutes. In another example, if a boiling point B2 of the solvent in the ink 1184 is in a range B2>180° C., the predetermined amount corresponding to each nozzle 1182 is in an approximate range of 100˜5000 droplets, and the predetermined time interval T2 is roughly in a range of 1 minutes to 5 minutes. Preferably, the predetermined amount corresponding to each nozzle 1182 is in a range of 1000˜3000 droplets, and the predetermined time interval T2 is roughly in a range of 1 minute to 3 minutes. Generally, every 100,000 droplets of ink have a volume between 0.0001 cubic centimeters and 0.02 cubic centimeters.

According to this present embodiment, in Step 210 and Step 210′, the ink on/at the nozzle forming face can sufficiently retain moisture (i.e., any given droplet is not at the nozzle forming face long enough to dry out, even when the ink jet system is not in use to deposit ink on substrates) and thus prevent the opening of the nozzle from clogging. As such, the opportunity for adhesion of hardened ink, formed due to the drying of ink remaining within the nozzles over time, is reduced. In evidence, the ink jetting method 200 can be applied to different kinds of inks employing respective solvents with different boiling points, as long as the predetermined amount of droplets and predetermined time interval are selected properly.

Simply stated, the present ink jet method for forming patterned layers on substrates permits a predetermined number of substrates to have respective patterned layers formed thereon. The ink jet method, however, further prevents clogging of the ink jet system when not in use to coat/layer substrates. A further step is provided, after all the desired substrates have been patterned, that causes the ink jet head driving device to drive the ink jet head module to have a relative movement to move to a location over an ink receiver, jetting a predetermined amount of droplets of ink from the nozzles to the ink receiver within each predetermined time interval during/over the course of a predetermined amount of time. By jetting a number of droplets in a given period, each nozzle is able to remain unclogged (i.e., the ink in a nozzle does not have sufficient time to dry/harden prior to being jetted).

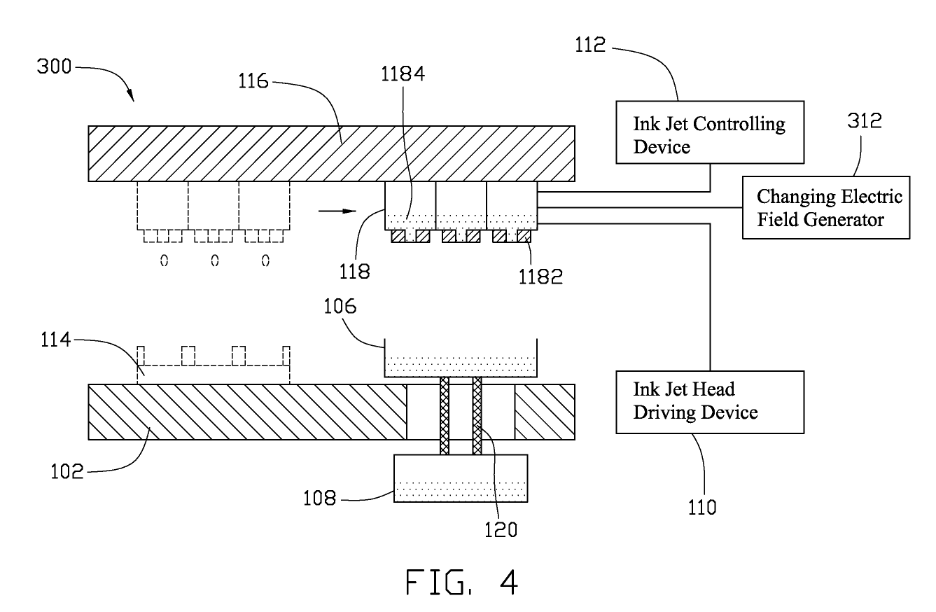

Referring to FIG. 4, an ink jet system 300 is illustrated in accordance with a third present embodiment. The distinguishing features between the ink jet system 300 and 100 are that the ink jet system 300 further includes a changing electric field generator 312. The changing electric field generator 312 is used to generate a changing electric field. The changing electric field is used in Step 210 of the ink jet method in the second preferred embodiment. The changing electric field can make the ink 1184 in the ink jet head 118 shaken, thus make the liquid level of the ink 1184 in the nozzle 1182 changed.

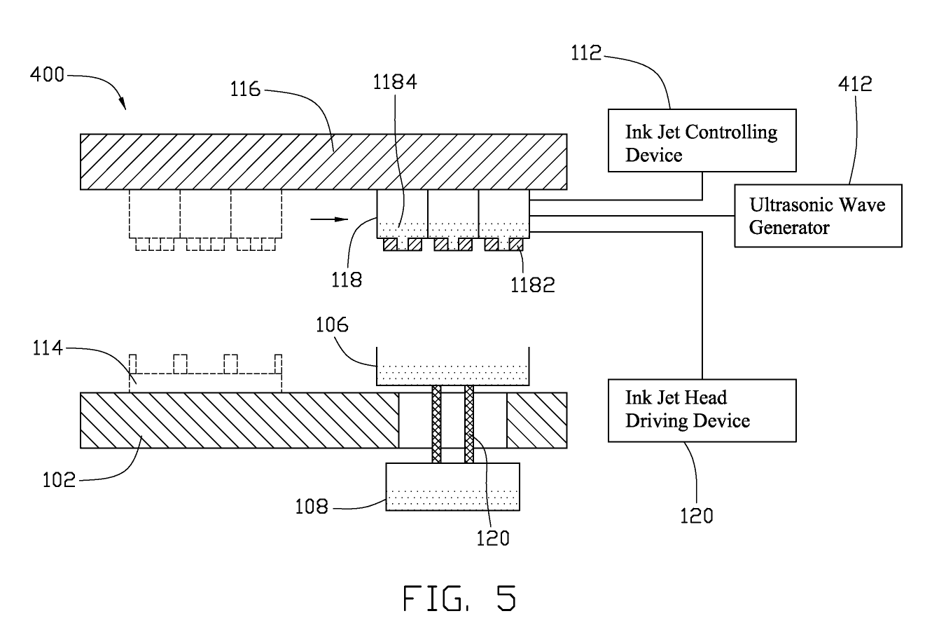

Referring to FIG. 5, an ink jet system 400 is illustrated in accordance with a fourth present embodiment. The distinguishing features between the ink jet system 400 and 100 are that the ink jet system 400 further includes an ultrasonic wave generator 412. The ultrasonic wave generator 412 is used to generate ultrasonic waves. The ultrasonic waves are used in Step 210 of the ink jet method in the second preferred embodiment. The ultrasonic waves can make the ink 1184 in the ink jet head 118 shaken, thus make the liquid level of the ink 1184 in the nozzle 1182 changed.

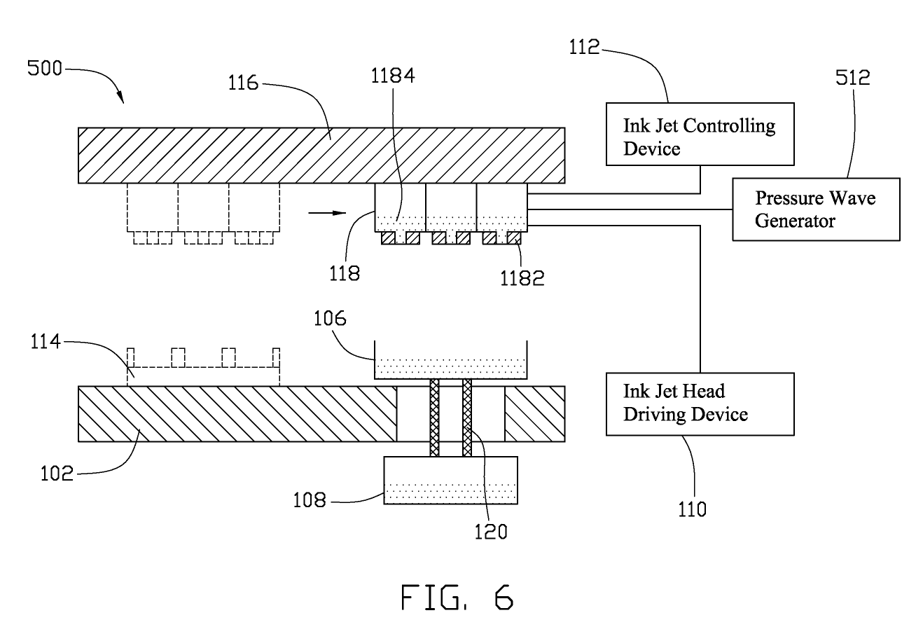

Referring to FIG. 6, an ink jet system 500 is illustrated in accordance with a fifth present embodiment. The distinguishing features between the ink jet system 500 and 100 are that the ink jet system 500 further includes pressure wave generator 512. The pressure wave generator 512 is used to generate pressure waves. The pressure waves are used in Step 210 of the ink jet method in the second preferred embodiment. The pressure waves can make the ink 1184 in the ink jet head 118 shaken, thus make the liquid level of the ink 1184 in the nozzle 1182 changed.

It is to be understood, however, that even though numerous characteristics and advantages of the present invention have been set forth in the foregoing description, together with details of the structure and function of the invention, the disclosure is only illustrative, and changes may be made in detail. Especially changes in matters of shape, size, and arrangement of parts; within the principles of the invention and to the full extent indicated by the broad or general meaning of the terms in which the appended claims are expressed.

What is claimed is:

1. An ink jet method for separately forming patterned layers on respective substrates, comprising:
Step 1: providing an ink jet system and at least one substrate, the ink jet system comprising an ink jet head module, the ink jet head module containing a plurality of nozzles;
Step 2: jetting ink from the nozzles onto the given substrate to form a pattern layer on the substrate;
Step 3: removing the given substrate with the patterned layer formed thereon;
Step 4: making the liquid level of the ink in the nozzle changed within each predetermined time interval during/over the course of a predetermined amount of time.

2. The ink jet method as described in claim 1, wherein the ink jet system further comprises an ink receiver, the ink jet method further comprising a step between step 3 and step 4: driving the ink jet head module to have a relative movement to a location over the ink receiver.

3. The ink jet method as described in claim 2, wherein in Step 4, the change of the liquid level causes a predetermined amount of droplets of ink to jet from the nozzles to the ink receiver.

4. The ink jet method as described in claim I, further comprising a step between step 3 and step 4: providing another substrate, and repeating the steps 2 and 3 until a predetermined number of substrates have respective patterned layers formed.

5. The ink jet method as described in claim 3, wherein the ink contains a solvent with a boiling point lower than 100° C., the predetermined amount of droplets jetted from a given nozzle being in an approximate range of 100˜5000 droplets, the predetermined time T1 being about in a range of 20 seconds to 5 minutes.

6. The ink jet method as described in claim 3, wherein the ink contains a solvent with a boiling point lower than 100° C., the predetermined amount of droplets jetted from a given nozzle being in an approximate range of 2000˜3000 droplets, the predetermined time T1 being about in a range of 30 seconds to 2.5 minutes.

7. The ink jet method as described in claim 3, wherein the ink contains a solvent with a boiling point higher than 180° C., the predetermined amount of droplets jetted from a given nozzle being in an approximate range of 100˜5000 droplets, the predetermined time T1 being roughly in a range of 1 minutes to 5 minutes.

8. The ink jet method as described in claim 3, wherein the ink contains a solvent with a boiling point higher than 180° C., the predetermined amount of droplets jetted from a given nozzle being in an approximate range of 1000˜3000 droplets, the predetermined time T1 being roughly in a range of 1 minutes to 3 minutes.

9. The ink jet method as described in claim 3, wherein about 100,000 droplets of the ink have a volume between 0.0001 cubic centimeters and 0.02 cubic centimeters.

10. The ink jet method as described in claim 3, wherein the ink jet system further comprises an ink jet controlling device, the ink jet controlling device being configured to control the inkjetting of the nozzles.

11. The ink jet method as described in claim 1, wherein the change of the liquid level of the ink in the nozzle is made via a changing electric field generator, an ultrasonic wave generator or a pressure wave generator.

12. An ink jet method for separately forming patterned layers on respective substrates, comprising:
providing an ink jet system, the ink jet system comprising an ink jet head module, and an ink receiver, the ink jet head module containing a plurality of nozzles;
using the ink jet system to pattern respective layers on a given number of substrates; and
after the given number of substrates have been patterned, driving the ink jet head module to move to a location over the ink receiver, jetting a predetermined amount of droplets of ink from the respective nozzles to the ink receiver within each predetermined time interval during the course of a predetermined amount of time, in order to prevent each nozzle from clogging.
